(19) United States
(12) Patent Application Publication
(10) Pub. No.: US 2019/0337007 A1
(43) Pub. Date: Nov. 7, 2019

(54) SPRAY GUN AIR CAP WITH RETENTION MEANS

(71) Applicant: 3M INNOVATIVE PROPERTIES COMPANY, St. Paul, MN (US)

(72) Inventors: Brady P. Haislet, Maple Plain, MN (US); Bryan J. Hayward, St. Paul, MN (US)

(21) Appl. No.: 16/466,716

(22) PCT Filed: Dec. 5, 2017
(86) PCT No.: PCT/IB2017/057668

§ 371 Date: Jun. 5, 2019

Related U.S. Application Data
(60) Provisional application No. 62/430,393, filed on Dec. 6, 2016.

(51) Int. Cl. B05B 15/652; B05B 7/08; B05B 7/12

(52) U.S. Cl. CPC B05B 15/652; B05B 7/12; B05B 7/083

(57) ABSTRACT

A spray gun air cap is disclosed comprising a forward end, a retention end opposite the forward end, a spray axis passing through the retention end and the forward end, and a sidewall positioned between the forward end and the retention end. The sidewall comprises a first air cap retention system comprising a reception feature comprising a retainer window opening to the retention end and extending toward the forward end. The retention system further includes an air cap rotation guide intersecting the retainer window and tracing an arc about the spray axis, the air cap rotation guide comprising a retention wall facing the forward end.

### BACKGROUND

Spray guns are known for the application of coatings to various substrates. It has been known to provide spray guns with air caps having air horns for the purpose of shaping a spray pattern. Such air caps are typically secured to the spray gun by means of a threaded ring that captures the air cap against the spray gun body. There is a need for improved connections between air caps and spray gun bodies.

### SUMMARY OF THE INVENTION

Exemplary embodiments according to the present disclosure include, but are not limited to, the embodiments listed below, which may or may not be numbered for convenience. Several additional embodiments, not specifically enumerated in this section, are disclosed within the accompanying detailed description.

### EMBODIMENTS

1. A spray gun air cap comprising
a forward end;
a retention end opposite the forward end;
a spray axis passing through the retention end and the forward end;
a sidewall positioned between the forward end and the retention end;
wherein the sidewall comprises a first air cap retention system comprising
a reception feature comprising a retainer window opening to the retention end and extending toward the forward end; and
an air cap rotation guide intersecting the retainer window and tracing an arc about the spray axis, the air cap rotation guide comprising a retention wall facing the forward end.

2. The spray gun air cap of Embodiment 1 comprising an endwall at the retention end, wherein the endwall comprises the retainer window.

3. The spray gun air cap of any of Embodiments 1 or 2 wherein the retainer window extends through the sidewall toward the forward end.

4. The spray gun air cap of any of Embodiments 1-3 wherein the air cap rotation guide extends through the sidewall.

5. The spray gun air cap of any of Embodiments 1-4 wherein the air cap rotation guide comprises a first end stop positioned at a first end of the arc.

6. The spray gun air cap of Embodiment 5 wherein the air cap rotation guide comprises a second end stop positioned at a second end of the arc.

7. The spray gun air cap of Embodiment 6 wherein the retainer window is positioned at an intermediate arcuate location between the first end stop and the second end stop.

8. The spray gun air cap of Embodiment 7 wherein the arc spans an angle about the spray axis in a range from 60 degrees to 120 degrees from the first end of the arc to the second end of the arc.

9. The spray gun air cap of Embodiment 8 wherein the retainer window is positioned at an angle in a range from 30 degrees to 60 degrees from one of the first end stop or the second end stop.

10. The spray gun air cap of any of Embodiments 8 or 9 wherein the arc spans an angle about the spray axis of 90 degrees from the first end of the arc to the second end of the arc

11. The spray gun air cap of any of Embodiments 8-10 wherein the retainer window is positioned at an angle of 45 degrees from one of the first end stop or the second end stop.

12. The spray gun air cap of any of Embodiments 1-11 wherein the reception feature comprises a hand grip adapted to facilitate manual rotation of the air cap about the spray axis.

13. The spray gun air cap of any of Embodiments 1-12 wherein the sidewall comprises a second air cap retention system opposite the spray axis from the first air cap retention system.

14. The spray gun air cap of any of Embodiments 1-12 comprising one of a retention rib or a retention channel positioned in the sidewall.

15. The spray gun air cap of Embodiment 14 wherein the retention rib or retention channel is positioned closer to the forward end than the air cap rotation guide.

16. A spray gun nozzle assembly comprising a nozzle body and a spray gun air cap according to any preceding Embodiment.

17. The spray gun nozzle assembly of Embodiment 16 wherein the nozzle body comprises a nozzle body retainer feature adapted to pass through the retainer window on the spray gun air cap.

18. The spray gun nozzle assembly Embodiment 17 wherein the nozzle body retainer feature is adapted to pass through the air cap rotation guide.

19. The spray gun nozzle assembly of any of Embodiments 17 or 18 wherein the nozzle body retainer feature cooperates with a rearward-oriented face of the retention wall on the spray gun air cap to retain the air cap against the nozzle body.

20. The spray gun nozzle assembly of any of Embodiments 16-19 wherein the spray gun air cap comprises a second air cap retention system comprising a second retention wall, and wherein the nozzle body comprises a second nozzle body retainer feature; wherein the second nozzle body retainer feature cooperates with the second retention wall on the spray gun air cap to retain the air cap against the nozzle body.

21. The spray gun nozzle assembly of any of Embodiments 16-20 wherein the nozzle body comprises a retention channel positioned to cooperate with the retention rib on the spray gun air cap.

22. The spray gun nozzle assembly of any of Embodiments 16-21 wherein the nozzle body comprises a primary air cap sealing feature positioned to cooperate with a sealing surface on the spray gun air cap.

23. The spray gun nozzle assembly of any of Embodiments 16-22 wherein the nozzle body is integral with a spray gun body.

24. The spray gun nozzle assembly of any of Embodiments 16-22 wherein the nozzle body is separable from a spray gun body.

25. A method of assembling an air cap to a nozzle body comprising aligning a retention end of a spray gun air cap with a nozzle body along a spray axis such that a retainer window on the spray gun air cap is rotationally aligned with a nozzle body retainer feature; and translating the spray gun air cap toward the nozzle body to cause the nozzle body retainer feature to pass into the retainer window.

26. The method of Embodiment 25 comprising, after causing the nozzle body retainer feature to pass into the retainer window, continuing to translate the spray gun air cap toward the nozzle body to cause a snapping of the spray gun air cap onto the nozzle body.

27. The method of Embodiment 25 wherein snapping of the spray gun air cap onto the nozzle body comprises seating a retention rib on one of the spray gun air cap or the nozzle body into a retention channel on the other of the spray gun air cap or the nozzle body.

28. The method of any of Embodiments 25-27 comprising, after causing the nozzle body retainer feature to pass into the retainer window, rotating the spray gun air cap about the spray axis with respect to the nozzle body to cause the nozzle body retainer feature to ride along an air cap rotation guide.

29. The method of Embodiment 28 wherein, while the nozzle body retainer feature resides in the air cap rotation guide, the nozzle body retainer feature bears against a retention wall to resist separation of the spray gun air cap from the nozzle body.

30. The method of any of Embodiments 25-29 comprising rotating the spray gun air cap in a first direction about the spray axis with respect to the nozzle body to cause the nozzle body retainer feature to ride along an air cap rotation guide until the nozzle body retainer feature contacts a first end stop.

31. The method of Embodiment 30 comprising rotating the spray gun air cap in a second direction opposite the first direction about the spray axis with respect to the nozzle body to cause the nozzle body retainer feature to ride along the air cap rotation guide until the nozzle body retainer feature contacts a second end stop.

32. The method of Embodiment 31 wherein the air cap rotation guide spans an arc about the spray axis from a first end of the arc to a second end of the arc, wherein the first end stop is located at the first end and the second end stop is located at the second end, the method comprising rotating the spray gun air cap throughout the arc to cause the nozzle body retainer feature to contact the first end stop and the second end stop.

33. The method of any of Embodiments 31 or 32 wherein the retainer window is positioned at an intermediate arcuate location between the first end stop and the second end stop, wherein the nozzle body retainer feature can pass transversely through the retainer window as the spray gun air cap is rotated between the first end stop and the second end stop.

34. The method of any of Embodiments 28-33 comprising
after rotation of the spray gun air cap, rotationally aligning with a nozzle body retainer feature with retainer window; and
translating the spray gun air cap away from the nozzle body to cause the nozzle body retainer feature to pass out of the retainer window to disassemble the spray gun air cap from the nozzle body.

The words “preferred” and “preferably” refer to embodiments described herein that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the terms “comprises” and variations thereof do not have a limiting meaning where these terms appear in the accompanying description. Moreover, “a,” “an,” “the,” “at least one,” and “one or more” are used interchangeably herein.

Relative terms such as left, right, forward, rearward, top, bottom, side, upper, lower, horizontal, vertical, and the like may be used herein and, if so, are from the perspective observed in the particular figure. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

The above summary is not intended to describe each embodiment or every implementation of the reservoirs and associated vent assemblies described herein. Rather, a more complete understanding of the invention will become apparent and appreciated by reference to the following Description of Illustrative Embodiments and claims in view of the accompanying figures of the drawing.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIGS. 1-6 depict exemplary liquid spray guns comprising air caps according to the present disclosure;

FIGS. 7 and 8 depict exemplary liquid spray guns wherein a liquid spray gun nozzle assembly has been removed;

FIG. 9 is a left side exploded assembly view of an exemplary liquid spray gun nozzle assembly comprising an air cap in an assembly position according to the present disclosure;

FIG. 10 is a top view of the exploded assembly view of FIG. 9;

FIG. 11 is a perspective exploded assembly view of an exemplary liquid spray gun nozzle assembly comprising an air cap in an assembly position according to the present disclosure;

FIG. 12 depicts the assembly of FIG. 11 wherein the air cap has been translated onto the nozzle body;

FIG. 13 depicts the assembly of FIGS. 11-12 wherein the air cap has been rotated into a first fan position;

FIG. 14 is a perspective view of an exemplary nozzle body according to the present disclosure;

FIG. 15 is a front view of the nozzle body of FIG. 14;

FIG. 16 is a left side view of the nozzle body of FIG. 14;

FIG. 17 is a bottom view of the nozzle body of FIG. 14;

FIG. 18 is a front perspective view of an exemplary air cap according to the present disclosure;

FIG. 19 depicts the air cap of FIG. 18 as viewed straight-on toward a reception feature;

FIG. 20 depicts a front view of the air cap of FIG. 18;

FIG. 21 depicts a rear view of the air cap of FIG. 18;

FIG. 22 depicts a left side view of the air cap of FIG. 18;

FIG. 23 depicts a rear perspective view of the air cap of FIG. 18;

FIG. 24 is a rear view of an exemplary liquid spray gun nozzle assembly according to the present disclosure;

FIG. 25 is a front perspective view of the liquid spray gun nozzle assembly of FIG. 24;

FIG. 26 is a cross-section view taken at 26-26 of FIG. 24; and

FIG. 26A is a detailed view showing a portion of FIG. 26.

### DETAILED DESCRIPTION

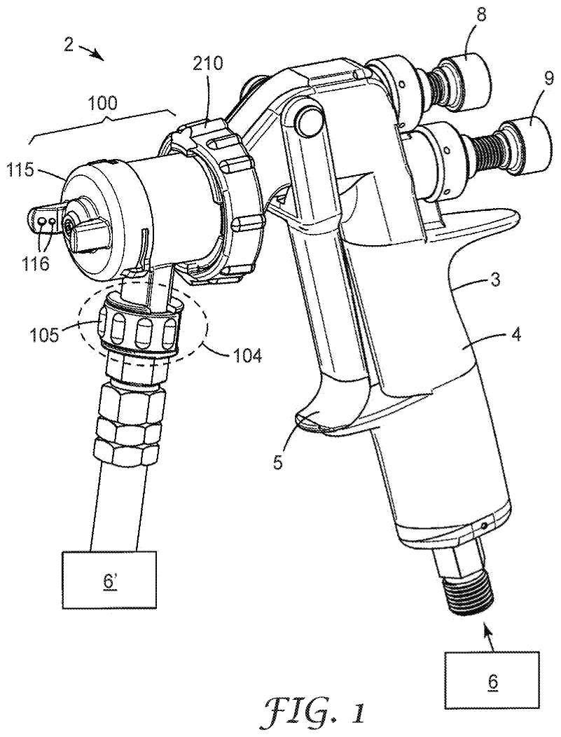

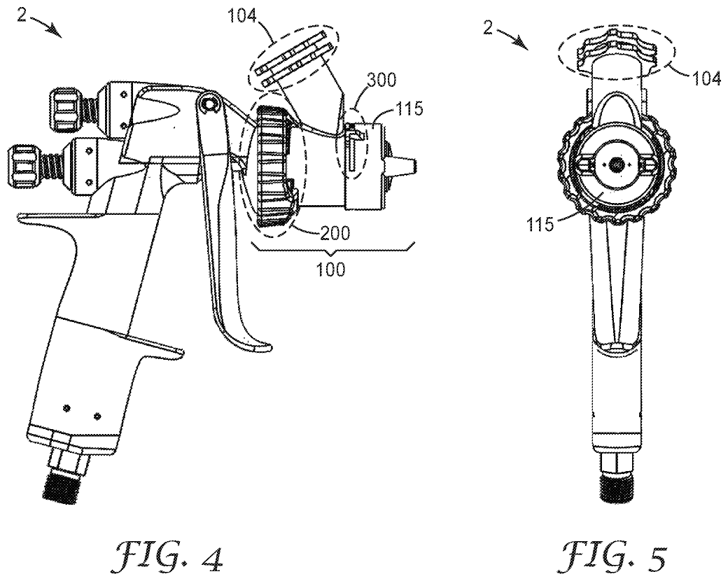

Referring to FIGS. 1 through 6, various exemplary embodiments of a liquid spray gun 2 are shown. The liquid spray gun 2 comprises a handle 4, a trigger 5, a connection for an external pressure source 6, a liquid spray gun body 3, a liquid needle adjustment control knob 9, a shaping air control knob 8, and a liquid spray gun nozzle assembly 100. The liquid spray gun nozzle assembly 100 comprises a spray gun connection portion 120 that is removable and attachable at a nozzle assembly connection portion 200 on the spray gun body 3.

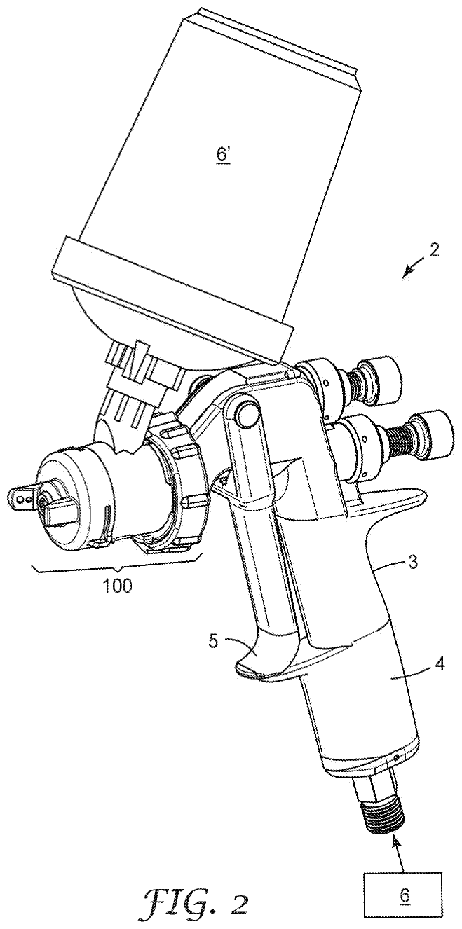

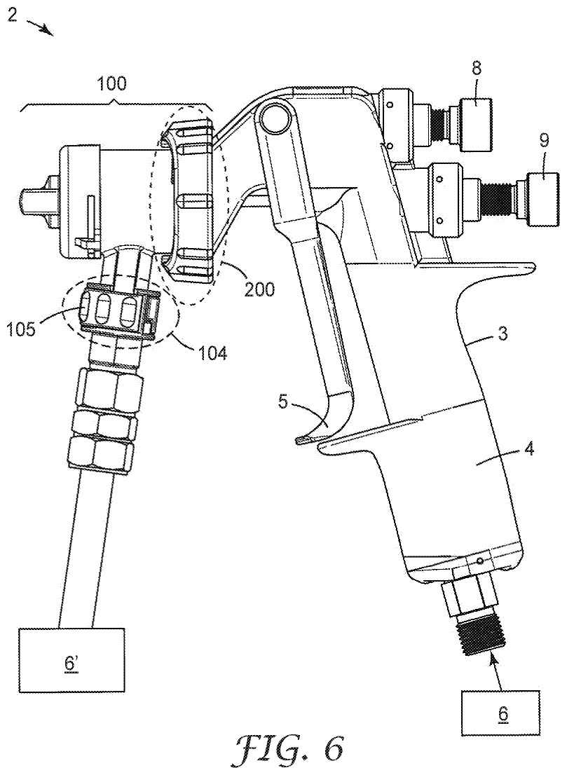

The liquid spray gun nozzle assembly 100 comprises one end of a liquid spray gun coating liquid connector 104 (located at a coating liquid inlet portion 102), through which a coating liquid is supplied to the liquid spray gun 2 from an external liquid source 6′. As shown, for example, in FIGS. 1 and 6, the liquid connector 104 comprises a quick-connect coupler 105. Such a quick-connect coupler is described, for example, in U.S. provisional patent application No. 62/430,388 (3M Docket No. 77385US002), entitled “Paint Spray Gun Coating Liquid Connector,” filed Dec. 6, 2016, the disclosure of which is herein incorporated by reference in its entirety. Other liquid connectors are possible. For example, the liquid connector 104 may comprise connections, or features of connections, described in WO2017/123707; WO2017/123714; WO2017/123715; WO2017/123718; and/or in U.S. Pat. Pub. Nos. 2013/0221130 A1 (“Spraygun with built-in quick-fit connector”); 2004/0016825 A1 (“Mixing cup adapting assembly”); 2015/0090614 A1 (“Apparatus for spraying liquids, and adapters and liquid reservoirs suitable for use therewith”); 2006/0065761 A1 (“Easy clean spray gun”); 2016/0052003 A1 (“Liquid Spray gun, spray gun platform, and spray head assembly”); and/or 2015/0028131 (“Spray gun having internal boost passageway”), the disclosures of which are hereby incorporated by reference in their entireties. In particular, the liquid connector 104 may comprise a gravity-fed spray gun paint reservoir connector, an example of which is shown in FIGS. 2-5.

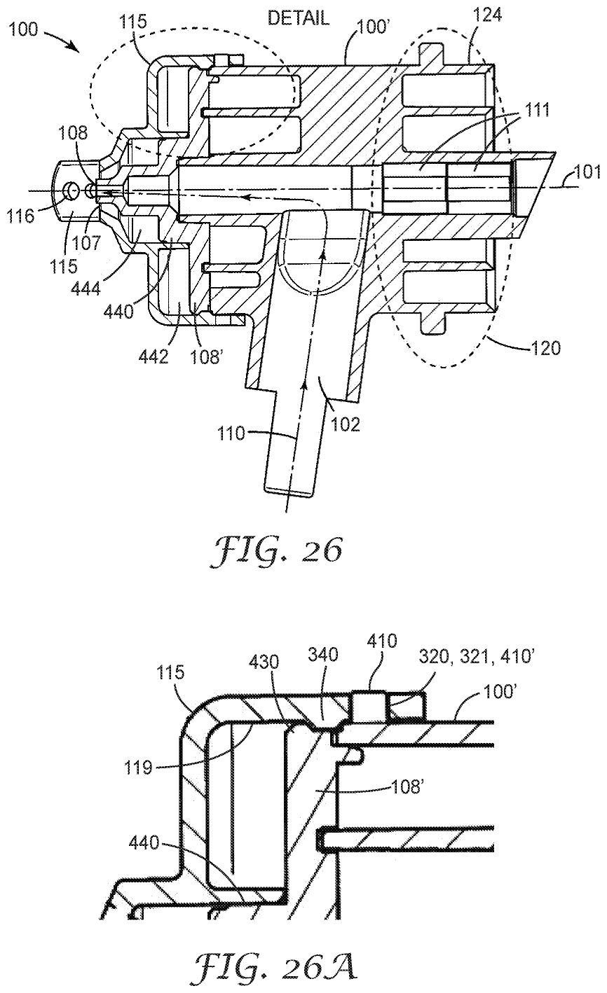

Within the liquid spray gun nozzle assembly 100 is a coating liquid flow path 110 through which the coating liquid flows from the liquid spray gun coating liquid connector 104 to a liquid nozzle 108 (see, e.g., FIG. 26). In operation, the coating liquid passes from the coating liquid inlet portion 102, along the coating liquid flow path 110, along a spray axis 101 parallel to a liquid needle 9′, and ultimately is expelled from the liquid nozzle 108 upon depressing the trigger 5. When the spray gun is idle (i.e., not spraying), the liquid needle 9′ typically occludes the liquid nozzle 108. The liquid needle is sealed by one or more liquid needle sealing elements 111 towards the rearward end of the coating liquid flow path 110 (as seen, for example, in FIG. 26, wherein the liquid needle 109 is not shown as the exemplary liquid spray gun nozzle assembly 100 is shown in a detached state). When the trigger 5 is depressed, the liquid needle 9′ is withdrawn from the liquid nozzle 108, thereby allowing the coating liquid to pass through. At the same time, depressing the trigger activates the pressurized air supply to assist in (depending on the gun type) urging coating liquid through and/or from the liquid nozzle 108, atomizing the coating liquid, or shaping the coating liquid (e.g., via the air cap 115, described below). The travel of liquid needle 9′ and the total air flow through the gun is adjusted via the liquid needle adjustment control 9. In the embodiment shown, the relative volume of air-flow among the air cap 115 (for shaping purposes) and a center air outlet 107 (for atomization purposes) is controlled via an air adjustment control 8. The forward end of the nozzle body 100′ comprises a nozzle plate 108′ which comprises the liquid nozzle 108 along with air guiding apparatus to guide shaping air and atomization air to the shaping air zone 442 and the center air zone 444 (described elsewhere) in the assembled air cap 115. In the embodiments shown, the nozzle plate 108′ is optionally provided as a separate part that is sealingly secured to the nozzle body 100′ by means of an adhesive, welding, or the like. In other embodiments, the nozzle plate 108′ is integral with the nozzle body 100′.

The liquid spray nozzle assembly comprises an air cap 115 affixed to the spraying end thereof. The air cap 115 can direct pressurized air advantageously toward the stream of coating liquid, e.g., via one or more shaping air outlets 116 located in one or more air horns 117, as it is expelled from the liquid nozzle 108 to assist in atomization of the coating liquid and shaping of the coating liquid jet into the desired spray pattern for a given application. Within the air cap or proximate the air cap, the center air outlet 107 directs air around the liquid outlet 108 to draw the coating liquid from the liquid nozzle 108 and (if desired) also impinges upon the coating liquid to atomize it, creating a fine mist of droplets. Optionally, one or more auxiliary air outlets 118 may be provided in the air cap 115 to further assist in shaping the spray pattern. Portions of the air cap 115, the center air outlet 107, the liquid nozzle 108, the air horns 117, the auxiliary air outlets 118, and the shaping air outlets 116 may be configured as described in U.S. Pat. Pub. Nos. 2016/0052003 A1 (“Liquid Spray gun, spray gun platform, and spray head assembly”); 2013/0327850 A1 (“Nozzle tips and spray head assemblies for liquid spray guns”); 2014/0246519 A1 (“Spray head assembly with integrated air cap/nozzle for a liquid spray gun”); 2013/0092760 A1 (“Spray head assemblies for liquid spray guns”); 2015/0069142 A1 (“Spray gun barrel with inseparable nozzle”); 2016/0151797 A1 (“Air caps with face geometry inserts for liquid spray guns”); 2016/0175861 A1 (“Nozzle assemblies, systems and related methods”); and/or in WO2015/191323; and/or WO2016/033415, the disclosures of which are hereby incorporated by reference in their entireties. In the embodiments shown, the coating liquid is contained entirely within the liquid spray gun nozzle assembly 100, thus generally avoiding the need to clean the liquid spray gun body 3 after use.

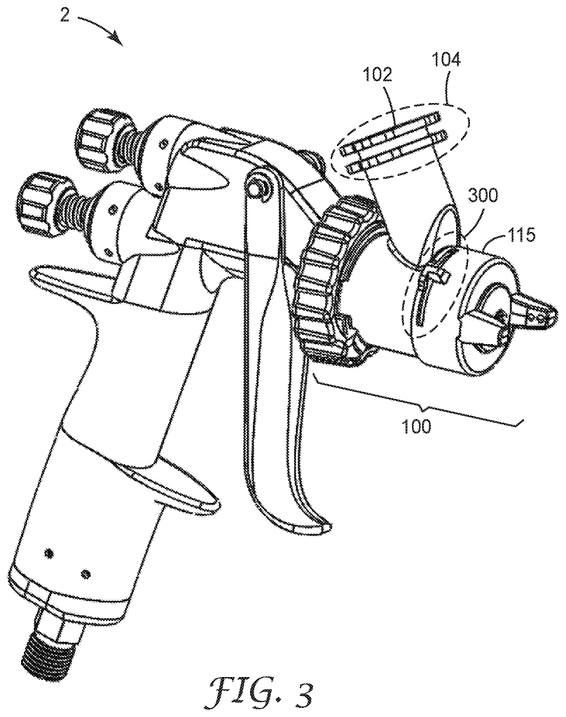

The external liquid source 6′ may be a container that is directly affixed to the liquid spray gun nozzle assembly 100 (see, e.g., FIG. 2), or may comprise a remote reservoir that is connected to the liquid spray gun nozzle assembly 100 by way of a hose. In some embodiments, the external liquid source is remotely pressurized (via a pressurized canister, a remote pump, or the like) to force the coating liquid into the liquid spray gun nozzle assembly 100. In other embodiments, the coating liquid may be forced or pulled into the liquid spray gun nozzle assembly 100 under the force of gravity (again, see FIG. 2), by way of a negative pressure induced by a venturi at the liquid nozzle 108, by a local pump, or through a combination of the above. Because the external liquid source can vary as described, it is shown in schematic form in FIGS. 1 and 3.

As shown, the nozzle assembly connection portion 200 facilitates the attachment of the paint spray gun nozzle assembly 100 to the paint spray gun body 3 by way of a locking ring 210 as described in U.S. provisional patent application No. 62/430,383 (3M Docket No. 77384US002), entitled “Spray Gun and Nozzle Assembly Attachment,” filed Dec. 6, 2016, the disclosure of which is herein incorporated by reference in its entirety. In other embodiments, the connection between the paint spray gun nozzle assembly 100 and the paint spray gun body 3 may be carried out by other means, such as, for example, a threaded collar, by one or more lever elements 130 as described, for example, in U.S. Pat. No. 8,590,809 B2 to Escoto, Jr. et al., by manually operable means for releasably mounting as described in U.S. Pat. No. 6,971,590 B2 to Blette et al., or by releasable mounts as described in U.S. patent publication number 2006/0065761 A1 to Joseph et al., the disclosures of which are herein incorporated by reference in their entirety. In other embodiments not shown herein, the paint spray gun nozzle assembly 100 is integral with (or at least not readily removable from) the spray gun body.

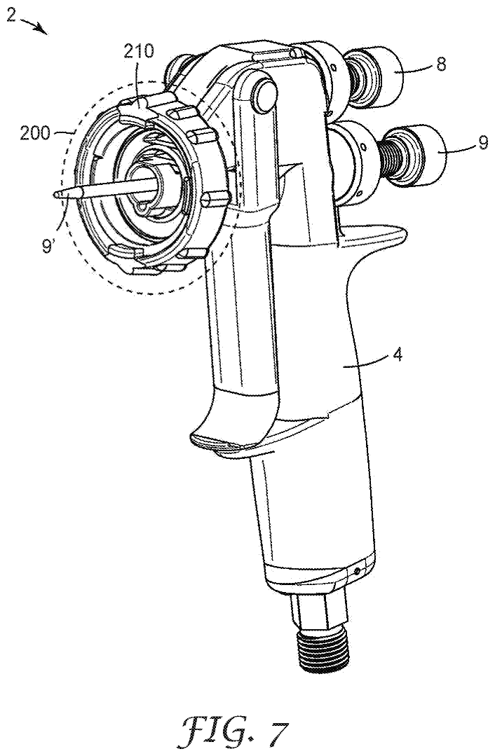

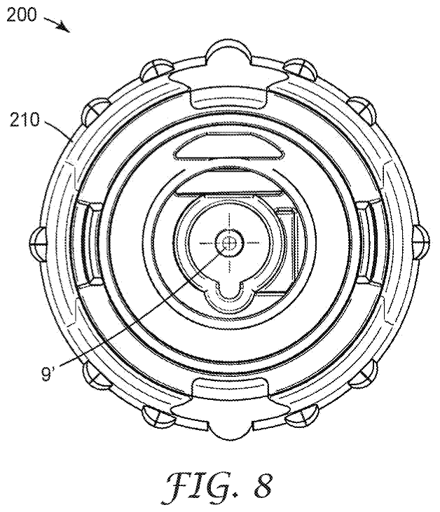

As shown in FIGS. 7 and 8, a liquid needle 9′ is affixed to the liquid spray gun body 3, such that cleaning of the liquid spray gun body 3 is generally limited to wiping or otherwise clearing the tip of the liquid needle after detaching the liquid spray gun nozzle assembly 100. In other embodiments, the liquid needle may be housed in the liquid spray gun nozzle assembly 100 such that it is removable from the liquid spray gun body 3 along with the liquid spray gun nozzle assembly 100. In either case, the liquid spray gun nozzle assembly 100, if disposable, may be discarded after use such that no further cleanup is required. Alternatively, the liquid spray gun nozzle assembly 100, if reusable, is the only portion of the liquid spray gun 2 left to clean. Both configurations can result in reduced cleanup time and materials, such as solvents, compared to what is typically required in a conventional spray gun.

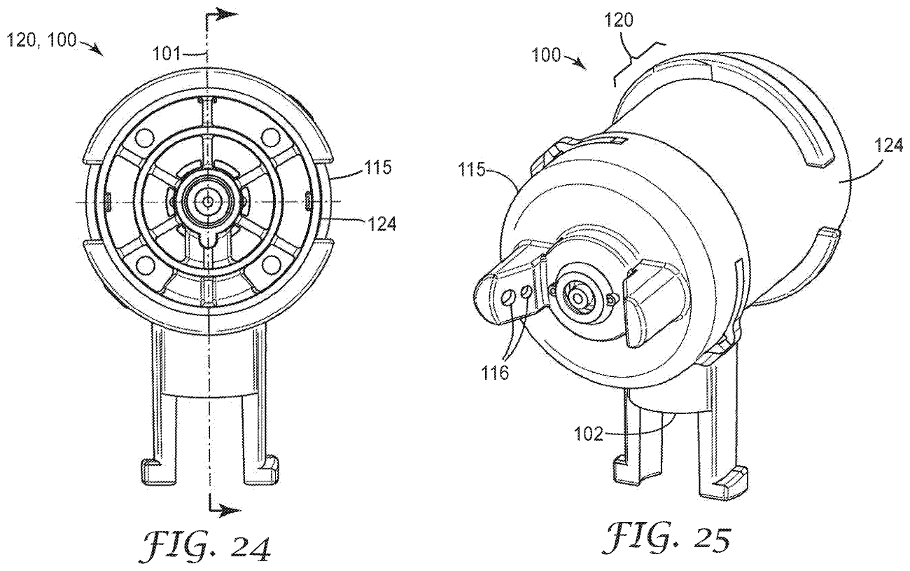

The exemplary nozzle assembly connection portion 200 facilitates the attachment of the liquid spray gun nozzle assembly 100 to the liquid spray gun body 3 by way of a captured, rotatable locking ring 210, as seen in FIGS. 1-8. FIG. 8 shows the nozzle assembly connection portion 200 as viewed along the spray axis 101. A corresponding view of the spray gun connection portion 120 of a liquid spray gun nozzle assembly 100 is shown in FIG. 24.

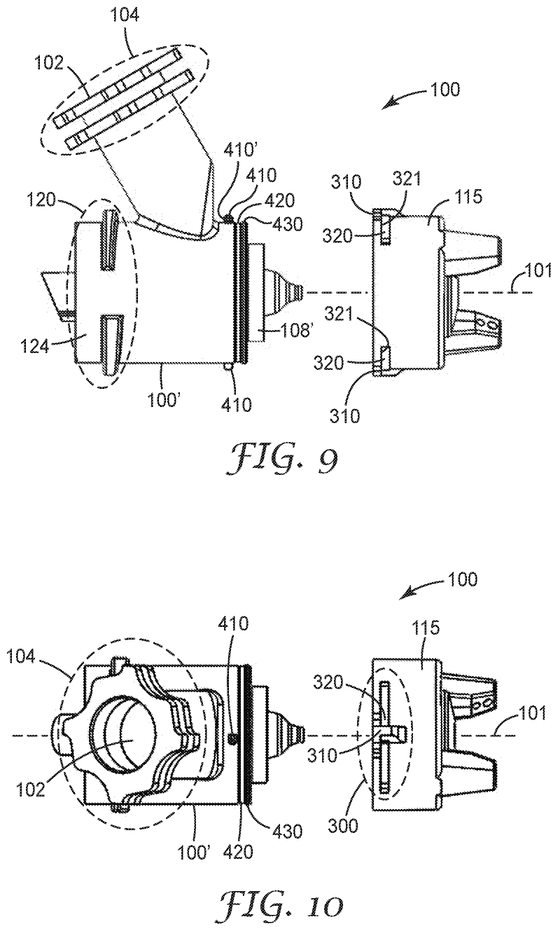

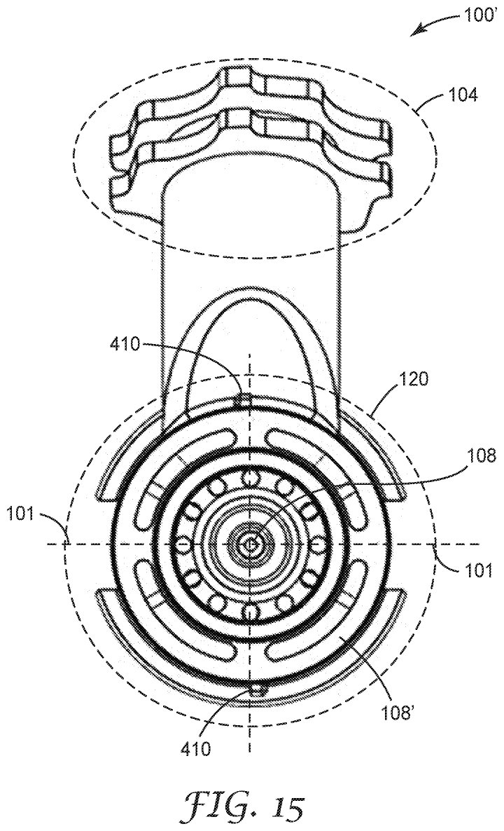

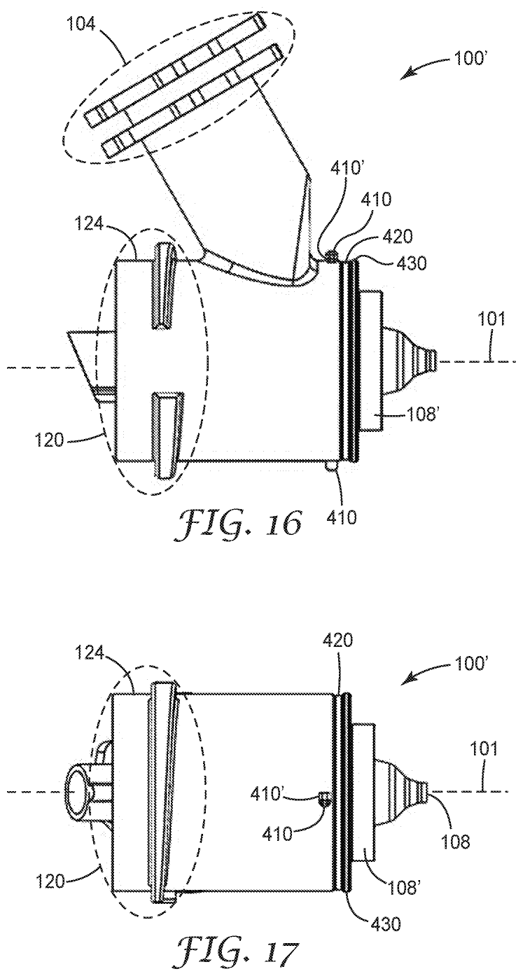

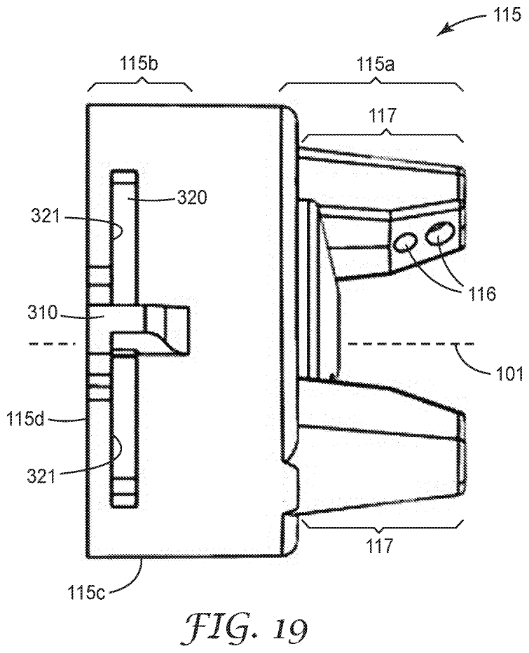

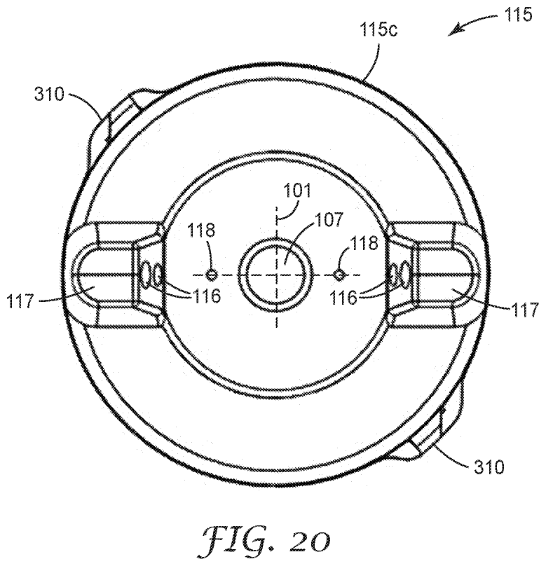

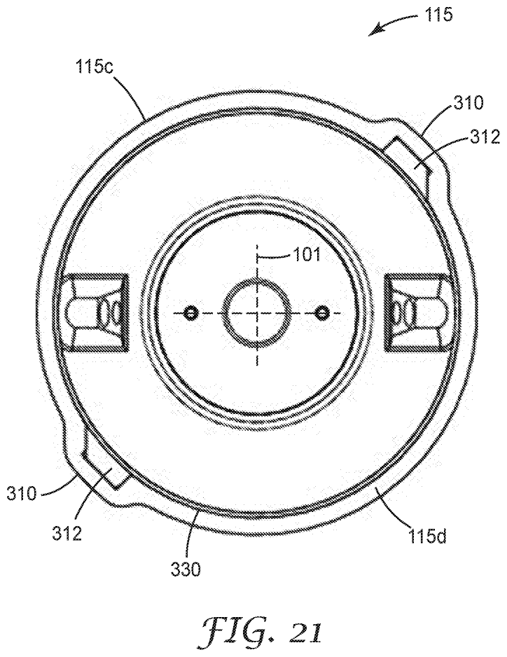

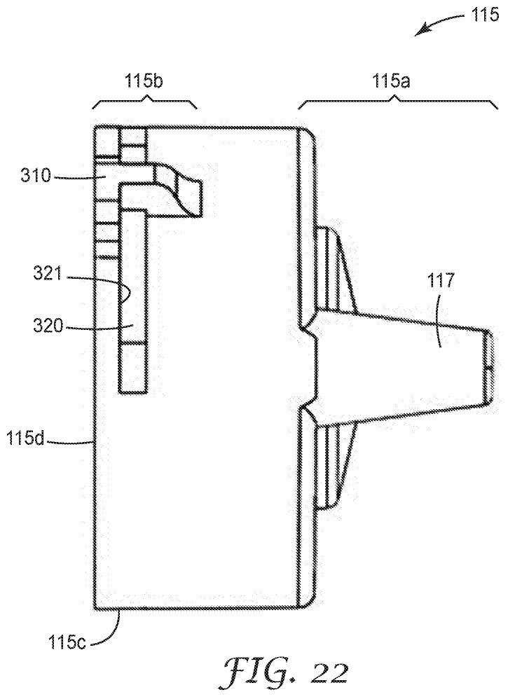

Referring now to FIGS. 9-26, an air cap retention system 300 is described in detail. As previously described, the spray gun nozzle assembly 100 may comprise an air cap 115. The air cap 115 may be retained to a nozzle body 100′ of the spray gun nozzle assembly 100 by the air cap retention system 300. In particular, the air cap 115 may be rotatably retained thereon such that the air cap may be rotated to a first fan position and a second fan position, with each fan position allowing for a different spray pattern to be realized. In some embodiments, the air cap 115 is both removably retained and rotatably retained on the nozzle body 100′.

In FIGS. 9-11, the air cap 115 is shown apart from the nozzle body 100′, exploded along the spray axis 101. The air cap comprises a forward end 115a, a retention end 115b, a sidewall 115c, and an endwall 115d located at the retention end. The spray axis 101 passes through the forward end 115a and the retention end 115b. As used herein, “forward” refers to the end of the device or component of the device through which a coating liquid is sprayed (e.g., the end containing the liquid nozzle 108 when the air cap 115 is assembled to the nozzle body 100′), whereas “rearward” refers to the opposite direction along the spray axis 101. As can be seen, the air cap comprises one or more reception features 310, and the nozzle body comprises one or more corresponding nozzle body retainer features 410. The reception feature(s) 310 may be positioned proximate the retention end 115b of the air cap 115, which is the end that faces the nozzle body when the air cap 115 is installed.

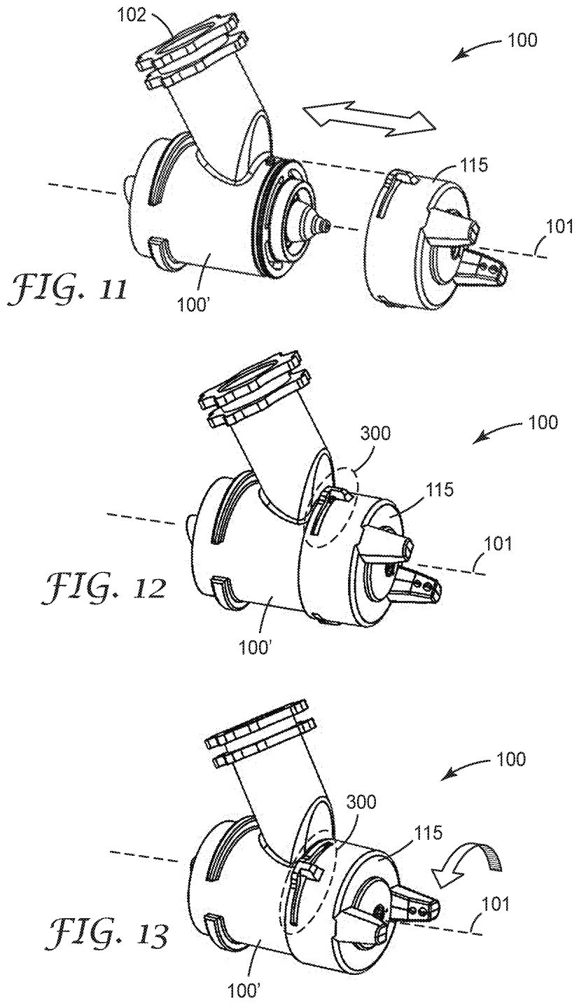

As best seen in FIG. 21, a reception feature 310 may comprise a retainer window 312 through which a nozzle body retainer feature 410 may pass upon installation of the air cap 115 onto the nozzle body 100′. In the embodiment shown, the air cap 115 is positioned as shown in FIG. 11 and is translated along the spray axis 101 and rotationally positioned so as to align the one or more reception features 310 with the corresponding nozzle body retainer features 410. As the air cap is translated, the nozzle body retainer feature(s) pass through the retainer window(s) 312. Once thus positioned (see, e.g., FIG. 12), the nozzle body retainer feature(s) have access to an air cap rotation guide 320 that permits the air cap 115 to rotate about the spray axis while being securely retained on the nozzle body 100′ (see, e.g., FIG. 13). In particular, since a rearward oriented face 410′ of the nozzle body retainer feature(s) 410 “ride” along a retention wall 321 of the air cap rotation guide 320, the air cap rotation guide 320 and the nozzle body retainer feature(s) 410 cooperate to prevent axial detachment of the air cap 115 from the nozzle body 100′.

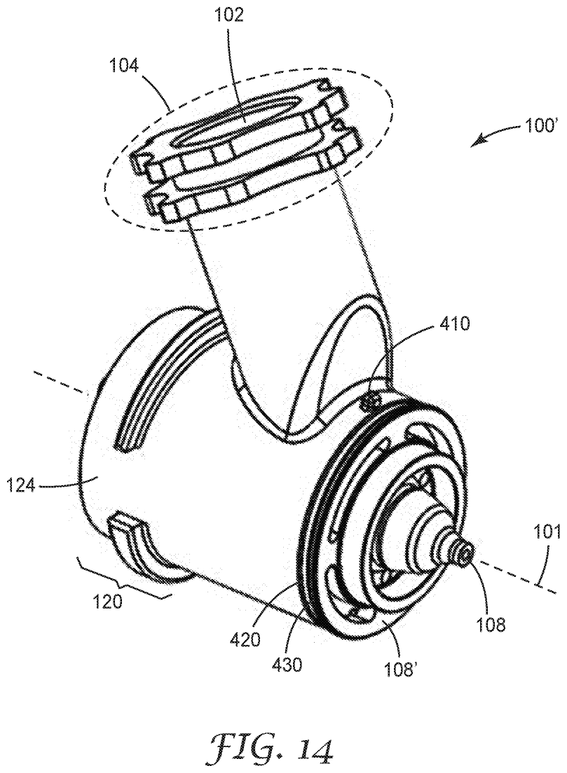

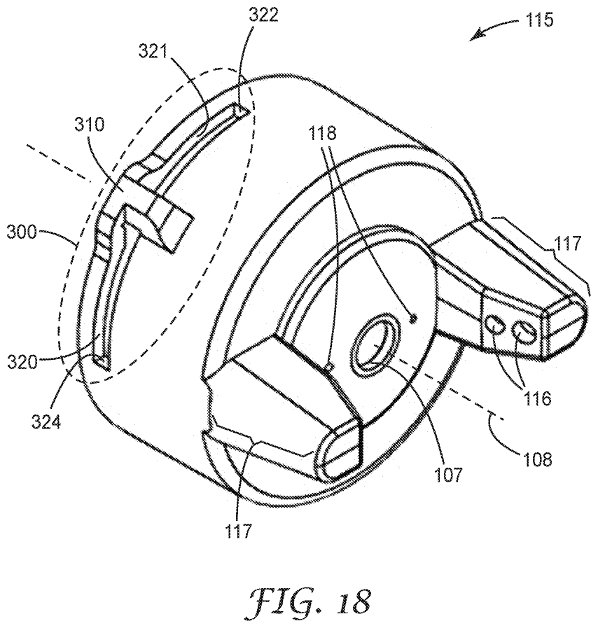

In the embodiments shown in the drawings, the nozzle body retainer feature(s) 410 comprise protrusions from the outer wall 124 of the nozzle body 100′ (see, e.g., FIGS. 14-17), while the retainer window(s) 312 and air cap rotation guide 320 comprise openings or recesses within the material of the air cap 115 (see, e.g., FIGS. 18-23). However, it should be understood that in some embodiments of the disclosure, these features could be either swapped to the opposite part (e.g., a rotation guide may be instead or additionally placed on the nozzle body 100′), or be provided as a different combination of protrusions and recesses, so long as the functions and benefits described herein are realized.

In some embodiments, the air cap rotation guide(s) 320 comprise first and second end stops 322, 324 to allow the user to position the air cap in preset rotational positions, as shown in FIG. 18. For example, when set up as shown in the appended figures, a nozzle body retainer feature 410 will contact a first end stop 322 when the air horns 117 are positioned horizontally on either side of the liquid nozzle, such that a vertical spray pattern can be obtained. Conversely, the air cap may be rotated 90 degrees in the clockwise direction until a nozzle body retainer feature 410 contacts a second end stop 324, such that the air horns 117 are positioned vertically above and below the liquid nozzle, so that a horizontal spray pattern can be obtained.

Assuming the above vertical and horizontal preset positions will be the most commonly chosen by the user, the user will want to assure secure retention of the air cap in those positions. Therefore, in the embodiments shown, the retainer window(s) 312 is located in an intermediate rotational position with respect to these preset positions. In particular, the retainer windows(s) 312 are located in a central rotational portion of the air cap rotation guide 320. For example, if the air horns 117 are positioned horizontally (for a vertical spray pattern) at a rotational position of 0 degrees, and the air horns 117 are positioned vertically (for a horizontal spray pattern) at a rotational position of 90 degrees, the retainer window(s) 312 may be positioned along the air cap rotation guide 320 such that the air cap 115 may be installed and/or removed at a rotational position of 45 degrees. Of course, this angle need not be precisely 45 degrees, but may be chosen to be any angle that permits secure retention at desired preset rotational position(s) while allowing installation/removal at another position. For example, the rotational position of the retainer window may be chosen in a range from 30 degrees to 60 degrees from either the first or second end stop. Because one or more retention grooves 420 and retention ribs 340 may be provided to allow further security against detachment (i.e., security beyond just a rearward-oriented face 410′ of nozzle body retainer feature 410 bearing against a retention wall 321), the position of the retainer window 312 may in some embodiments be chosen to correspond with the location of the first or second end stop (i.e., positioned at an angle of 0 degrees from an end stop).

The air cap 115 may be removed for cleaning and/or replaced, if desired, by aligning the retainer window(s) 312 with the nozzle body retainer feature(s) 410 and pulling along the spray axis 101 to separate the air cap 115 from the nozzle body 100′. In this manner, the air cap 115 is rotated to a position where a rearward-oriented face 410′ of the nozzle body retainer feature 410 will not bear against a retention wall 321, and can thus be detached axially along the spray axis 101. In one embodiment, the user is provided with different air caps 115 for a given nozzle body 100′ and may wish to swap them depending on the desired application. For example, one air cap may comprise a different air horn geometry and/or different shaping air outlets, or may not contain any air horns at all (such as where no pattern shaping is needed). The present disclosure allows for such swapping without the need for loose auxiliary parts (e.g., the typically-provided threaded ring) that might otherwise be lost or damaged.

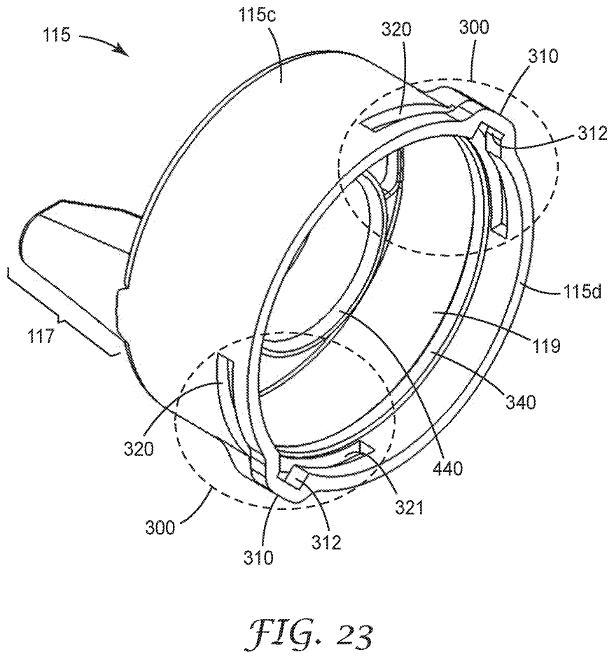

In some embodiments, the air cap 115 and/or the nozzle body 100′ further or alternatively comprise one or more cooperating retention channels 420 and retention ribs 340. Such cooperating features may provide enhanced resistance against axial separation of the air cap 115 from the nozzle body 100′. An exemplary retention channel 420 may be seen in isolation in FIGS. 14, 16, and 17. An exemplary retention rib 340 may be seen in isolation in FIG. 23. The features may be seen in cooperation in FIGS. 26 and 26A. As shown in the figures, a retention channel 420 may be positioned aft of an air cap sealing feature 430 (described below), defining the liquid nozzle 108 as the forward-facing end of the spray gun. In other embodiments, a retention channel 420 may be positioned forward of an air cap sealing feature 430. In some embodiments, the retention channel 420 need not comprise a two-sided channel as shown, but may comprise a one-sided step down in diameter into which a retention rib 340 may seat. Where provided, cooperating retention channels 420 and retention ribs 340 may further provide tracking to assist with smooth, guided rotation of the air cap 115 with respect to the nozzle body 100′. In some embodiments, a retention channel 420 may alternatively or additionally be provided on the air cap 115 and a cooperating retention rib 340 on the nozzle body 100′.

In some embodiments, a cooperating pair of a retention channel 420 and a retention rib 340 can act to provide a positive snap-fit of the air cap 115 onto the nozzle body 100′. Such snapping is realized by way of deformation and relaxation of the air cap 115 as it is pressed into place onto the nozzle body 100′. In particular, in the configurations depicted, the retention rib 340 must deform outwardly to clear an outer wall of the nozzle body 100′ (in this case the primary air cap sealing feature 430), and after so clearing will relax to become seated within the retention channel 420. If this relaxation is rapid, a snapping effect can be achieved. The snapping effect may be an effect that is felt by the user, but may also be audible if desired.

In some embodiments, the air cap 115 and/or the nozzle body 100′ comprise a primary air cap sealing feature 430. In the embodiments shown, the primary air cap sealing feature 430 comprises a ring-shaped member on the nozzle body 100′. Upon assembly of the air cap 115, the primary air cap sealing feature 430 presses against an air cap sealing surface 119 (which, as shown in the illustrated embodiments, comprises an inner wall of the air cap 115) with sufficient force and continuity to create a seal against compressed air, such seal being sufficient to essentially prevent compressed air from escaping the air cap around its rear perimeter under normal operating conditions. In some embodiments, the primary air cap sealing feature 430 is comprised of the same material as the remainder of the nozzle body 100′ (or another relatively non-resilient material), and provides a seal by virtue of simple cooperation with the air cap sealing surface 119. For example, the air cap 115 may comprise a thin enough wall and/or a soft enough material as to slightly deform outwardly due to the force applied by the air cap sealing feature. In such cases, the fit between the air cap 115 and the nozzle body 100′ may be described as an interference fit.

In some embodiments, a secondary air cap sealing feature 440 is further provided (see, e.g., FIGS. 26 and 26A). While the primary air cap sealing feature provides a seal isolating the region inside the air cap from a surrounding atmosphere, the secondary air cap sealing feature provides a seal that is internal to the air cap and separates the internal region into more than one zone. In the embodiments shown, a shaping air zone 442 is isolated between the primary and secondary air cap sealing features, while a center air zone 444 is isolated within the secondary air cap sealing feature 440. As depicted, the secondary air cap sealing feature 440 comprises cooperating surfaces that create an interference fit to prevent air leakage, for example via material deformation as described in the preceding paragraph.

It is also envisioned that sealing materials (e.g., elastomers) and/or members (e.g., o-rings, gaskets, etc.) may be provided instead of or in addition to an interference fit as described above.

Optionally, interaction between the primary air cap sealing feature 430 and the air cap sealing surface 119 further provides a degree of resistance against rotation of the air cap 115 relative to the nozzle body 100′. Where so provided, such resistance should be sufficient to prevent the air cap 115 from rotating on its own (e.g., in response to vibration, movement of the spray gun in use, or minor impacts), but permit the air cap 115 to be selectively rotationally positioned by hand about the spray axis 101 such that the desired spray pattern can be obtained by the user. For example, the user may wish (even during spraying) to quickly rotate the air cap 115 to change the pattern from vertical to horizontal (or some angle therebetween) in order to facilitate holding the spray gun in differing orientations and/or spraying differently situated and/or shaped surfaces. In this way, the user may advantageously rapidly alter the orientation of the spray pattern without the need to first loosen any parts, without the use of tools, and without breaking or compromising the seal between the air cap 115 and the nozzle body 100′ in the process.

In some embodiments, the one or more reception features 310 may further act as gripping features to facilitate the user's rotation of the air cap 115 to the desired rotational position, and also to assist with installation and/or removal of the air cap 115 from the nozzle body 100′.

In some embodiments, the air cap 115 may be provided as a disposable part, if desired, thereby minimizing replacement cost. Furthermore, the air cap 115 can be constructed of a resilient material (such as an injection molded polymer) not only to reduce cost but also to provide the necessary resilience needed to perform the sealing and rotational resistance functions as described herein (i.e., permitting the air cap sealing surface 119 to deform slightly to seal against the air cap sealing feature 430 and/or a retention rib 340 to seat into a cooperating retention channel 420.

It should be understood that, while the air caps 115 depicted in the appended figures in combination with a spray gun having a removable nozzle body 100′, the advantages described in the preceding several paragraphs are not limited to use on the depicted spray gun(s), and are applicable to other types of spray guns. For example, it is envisioned that, in a typical spray gun comprising an integral, non-removable liquid channel, the threaded retaining ring could be eliminated and replaced with the air cap retention system described herein. Therefore, wherever it is stated that features related to air cap retention, sealing, positioning, etc. may be located on the nozzle body 100′, it should be understood that such features may alternatively be located on a spray gun body. Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A spray gun air cap comprising
a forward end;
a retention end opposite the forward end;
a spray axis passing through the retention end and the forward end;
a sidewall positioned between the forward end and the retention end;
wherein the sidewall comprises a first air cap retention system comprising
a reception feature comprising a retainer window opening to the retention end and extending toward the forward end; and
an air cap rotation guide intersecting the retainer window and tracing an arc about the spray axis, the air cap rotation guide comprising a retention wall facing the forward end,
wherein the retainer window extends through the sidewall toward the forward end.

2. The spray gun air cap of claim 1 comprising an endwall at the retention end, wherein the endwall comprises the retainer window.

3. (canceled)

4. The spray gun air cap of claim 1 wherein the air cap rotation guide extends through the sidewall.

5. The spray gun air cap of claim 1 wherein the air cap rotation guide comprises a first end stop positioned at a first end of the arc.

6. The spray gun air cap of claim 5 wherein the air cap rotation guide comprises a second end stop positioned at a second end of the arc.

7. The spray gun air cap of claim 6 wherein the retainer window is positioned at an intermediate arcuate location between the first end stop and the second end stop.

8. (canceled)

9. (canceled)

10. (canceled)

11. (canceled)

12. The spray gun air cap of claim 1 wherein the reception feature comprises a hand grip adapted to facilitate manual rotation of the air cap about the spray axis.

13. The spray gun air cap of claim 1 wherein the sidewall comprises a second air cap retention system opposite the spray axis from the first air cap retention system.

14. The spray gun air cap of claim 1 comprising one of a retention rib or a retention channel positioned in the sidewall.

15. The spray gun air cap of claim 14 wherein the retention rib or retention channel is positioned closer to the forward end than the air cap rotation guide.

16. A spray gun nozzle assembly comprising a nozzle body and a spray gun air cap according to claim 1.

17. The spray gun nozzle assembly of claim 16 wherein the nozzle body comprises a nozzle body retainer feature adapted to pass through the retainer window on the spray gun air cap.

18. The spray gun nozzle assembly claim 17 wherein the nozzle body retainer feature is adapted to pass through the air cap rotation guide.

19. (canceled)

20. The spray gun nozzle assembly of claim 16 wherein the spray gun air cap comprises a second air cap retention system comprising a second retention wall, and wherein the nozzle body comprises a second nozzle body retainer feature; wherein the second nozzle body retainer feature cooperates with the second retention wall on the spray gun air cap to retain the air cap against the nozzle body.

21. The spray gun nozzle assembly of claim 16 wherein the nozzle body comprises a retention channel positioned to cooperate with the retention rib on the spray gun air cap.

22. The spray gun nozzle assembly of claim 16 wherein the nozzle body comprises a primary air cap sealing feature positioned to cooperate with a sealing surface on the spray gun air cap.

23. The spray gun nozzle assembly of claim 16 wherein the nozzle body is integral with a spray gun body.

24. The spray gun nozzle assembly of claim 16 wherein the nozzle body is separable from a spray gun body.

25. A method of assembling an air cap to a nozzle body comprising
aligning a retention end of a spray gun air cap with a nozzle body along a spray axis such that a retainer window on the spray gun air cap is rotationally aligned with a nozzle body retainer feature;
translating the spray gun air cap toward the nozzle body to cause the nozzle body retainer feature to pass into the retainer window;
rotating the spray gun air cap in a first direction about the spray axis with respect to the nozzle body to cause the nozzle body retainer feature to ride along an air cap rotation guide until the nozzle body retainer feature contacts a first end stop; and
rotating the spray gun air cap in a second direction opposite the first direction about the spray axis with respect to the nozzle body to cause the nozzle body retainer feature to ride along the air cap rotation guide until the nozzle body retainer feature contacts a second end stop,
wherein the retainer window is positioned at an intermediate arcuate location between the first end stop and the second end stop, wherein the nozzle body retainer feature can pass transversely through the retainer window as the spray gun air cap is rotated between the first end stop and the second end stop.

26. (canceled)

27. (canceled)

28. (canceled)

29. (canceled)

30. (canceled)

31. (canceled)

32. The method of claim 25 wherein the air cap rotation guide spans an arc about the spray axis from a first end of the arc to a second end of the arc, wherein the first end stop is located at the first end and the second end stop is located at the second end, the method comprising rotating the spray gun air cap throughout the arc to cause the nozzle body retainer feature to contact the first end stop and the second end stop.

33. (canceled)

34. (canceled)
